(19) United States
(12) Patent Application Publication
(10) Pub. No.: US 2008/0034852 A1
(43) Pub. Date: Feb. 14, 2008

(54) Intake manifold assembly

(76) Inventor: David J. Stroh, Farmington Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/464,326

(22) Filed: Aug. 14, 2006

(51) Int. Cl. G01M 19/00

(52) U.S. Cl. 73/118.1

(57) ABSTRACT

A torque adaptation system is provided. The system includes: a torque error estimator module that estimates a torque error based on an error propagation model and a plurality of torque model parameters; and an adapt torque module that adapts a model torque based on the torque error.

### TECHNICAL FIELD

The present invention relates to an intake manifold assembly for an internal combustion engine having a cross-plane crankshaft.

### BACKGROUND OF THE INVENTION

Internal combustion engines with eight cylinders arranged in a V-type configuration (two banks of four cylinders disposed at a generally ninety degree angle to each other) typically include a dual plane or cross-plane crankshaft. With a cross-plane crankshaft, each crank pin (of four) is positioned at a ninety degree angle from the previous, such that when viewed from one end of the crankshaft, along the longitudinal axis, that the crank pins form a cross shape. With a cross-plane crankshaft, a cylinder of the first bank of cylinders shares a crank pin with a cylinder of the second bank of cylinders. The cross-plane crankshaft can achieve very good engine balance as a result of counterweights formed integrally with the crankshaft. While the sequential firing of the cylinders is regular overall, the firing of each bank is not. Within the sequential firing order, two cylinders on each bank of cylinders will fire ninety crank angle degrees apart from one another, whereas all other cylinders on a respective bank fire at 180 crank angle degrees intervals.

With a boosted diesel engine, such as a turbo charged or supercharged engine, the second close firing cylinder of each bank tends to induct more intake air than the first close firing cylinder resulting in a greater amount of intake air trapped within the second close firing cylinder. As a result, at high intake air flow rates, the second close firing cylinder of each bank of cylinders will have comparatively higher peak in-cylinder pressures that may limit power output due to engine stress/fatigue constraints. Additionally, the remaining six cylinders, with comparatively low peak in-cylinder pressures, may operate below their power potential.

### SUMMARY OF THE INVENTION

An intake assembly is provided for a sequentially fired eight cylinder V-type internal combustion engine including a cylinder block having a first bank of cylinders and a second bank of cylinders wherein the first bank of cylinders defines the first, third, fifth, and seventh cylinder positioned from a first end to a second end of the engine. The second bank of cylinders defines the second, fourth, sixth, and eighth cylinder positioned from the first end to the second end of the engine. The intake assembly includes first and second intake plenums mounted with respect to the engine. Each of the first and second intake plenums are operable to communicate intake air to at least one of the first, third, fifth, and seventh cylinders. Additionally, third and fourth intake plenums are mounted with respect to the engine. Each of the third and fourth intake plenums are operable to communicate the intake air to at least one of the second, fourth, sixth, and eighth cylinders. The first bank of cylinders includes a first group of two cylinders that fire ninety crank angle degrees apart from each. The second bank of cylinders includes a second group of two cylinders that fire ninety crank angle degrees apart from each other. The first intake plenum is operable to communicate the intake air to one cylinder of the first group of two cylinders and the second intake plenum is operable to communicate the intake air to another cylinder of the first group of two cylinders. The third intake plenum is operable to communicate the intake air to one cylinder of the second group of two cylinders and the fourth intake plenum is operable to communicate the intake air to another cylinder of the second group of two cylinders.

The first, second, third, and fourth intake plenums may be mounted with respect to the engine in an outboard configuration. The intake assembly may further include an intake air duct and a first and second flow passage in downstream fluid communication with the intake air duct. First and second runner passages may be provided in downstream fluid communication with the first flow passage. The first and second runner passages may be provided in fluid communication with a respective one of the first and second intake plenums. Third and fourth runner passages may be provided in downstream fluid communication with the second flow passage. The third and fourth runner passages may be provided in fluid communication with a respective one of the third and fourth intake plenums. A compressor may be provided to pressurize the intake air. An internal combustion engine incorporating the disclosed intake assembly is also provided.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of an eight cylinder, V-type internal combustion engine having a sequential firing order of 1-2-7-8-4-5-6-3 and illustrating an intake manifold assembly consistent with the present invention;

FIG. 2 is a schematic plan view of an eight cylinder, V-type internal combustion engine have a sequential firing order of 1-5-6-3-4-2-7-8 and illustrating an alternate embodiment of the intake manifold assembly of the present invention;

FIG. 3 is a schematic plan view of an eight cylinder, V-type internal combustion engine have a sequential firing order of 1-2-7-3-4-5-6-8 and illustrating an alternate embodiment of the intake manifold assembly of the present invention;

FIG. 4 is a schematic plan view of an eight cylinder, V-type internal combustion engine have a sequential firing order of 1-2-6-3-4-5-7-8 and illustrating an alternate embodiment of the intake manifold assembly of the present invention;

### DESCRIPTION OF THE PREFERRED EMBODIMENTS

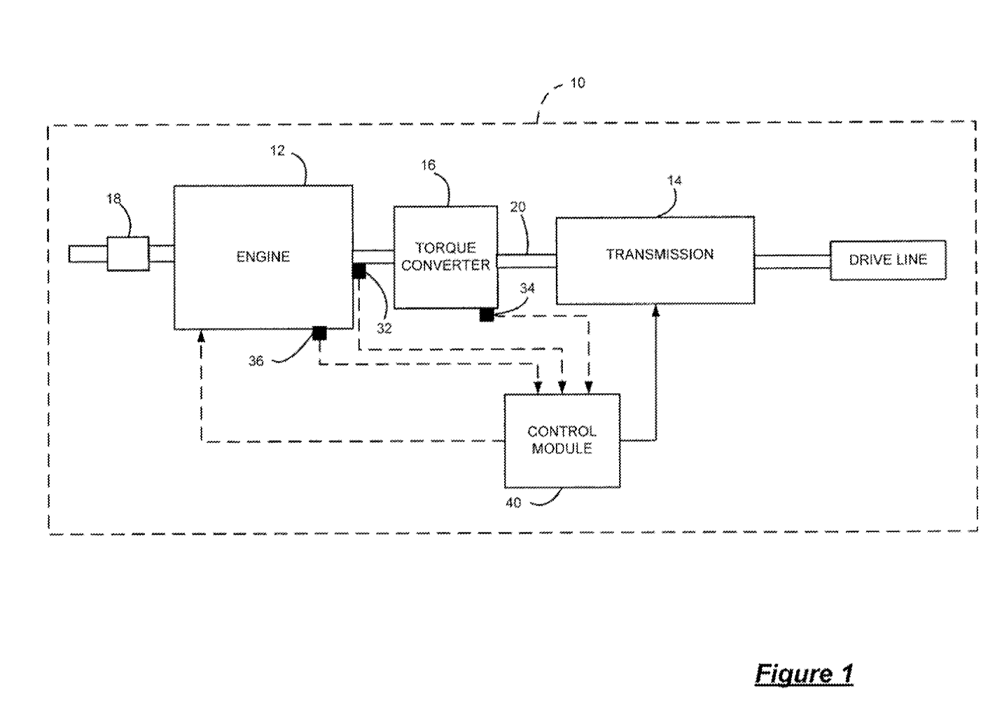

Referring to the drawings wherein like reference numbers correspond to like or similar components throughout the several figures, there is shown in FIG. 1 an internal combustion engine 10. The internal combustion engine 10 may be either a spark-ignited type or a compression-ignited type. For discussion hereinbelow, it will be assumed that the internal combustion engine 10 is a compression-ignited internal combustion engine. The internal combustion engine 10 includes a cylinder case or block 12 having a first bank of cylinders 14 and a second bank of cylinders 16. The first and second bank of cylinders 14 and 16 are arranged in a generally V-shaped configuration such that the internal combustion engine 10 may be characterized as a V-type internal combustion engine. The space at least partially defined by the included angle of the first and second bank of cylinders 14 and 16 is generally referred to as a valley 18.

Each of the first and second bank of cylinders 14 and 16 define a plurality of cylinders 20. Each of the cylinders 20 defined by the first bank of cylinders 14 are arranged from a first end of the internal combustion engine 10 to a second end of the internal combustion engine 10 as first cylinder 1, third cylinder 3, fifth cylinder 5, and seventh cylinder 7. Similarly, each of the cylinders 20 defined by the second bank of cylinders 16 are arranged from the first end of the internal combustion engine 10 to the second end of the internal combustion engine 10 as second cylinder 2, fourth cylinder 4, sixth cylinder 6, and eighth cylinder 8. As such, the internal combustion engine 10 may be further characterized by having eight cylinders 20.

The internal combustion engine may further include an intake manifold assembly 22. The intake manifold assembly is operable to provide intake air 24 to the cylinders 20 of the internal combustion engine 10 to enable combustion of fuel, not shown, within the cylinders 20. The intake manifold assembly 22 includes an intake air duct 26 in fluid communication with a first flow passage and a second flow passage 28 and 30, respectively. The first flow passage 28 is in fluid communication with a first plenum runner 32 and a second plenum runner 34. The first plenum runner 32 is operable to communicate intake air 24 to a first plenum 36 for subsequent introduction to at least one of the first cylinder 1, third cylinder 3, fifth cylinder 5, and seventh cylinder 7. The second plenum runner 34 is operable to communicate intake air 24 to a second plenum 38 for subsequent introduction to the at least one of the first cylinder 1, third cylinder 3, fifth cylinder 5, and seventh cylinder 7 that is not in fluid communication with the first intake plenum 36.

The second flow passage 30 is in fluid communication with a third plenum runner 40 and a fourth plenum runner 42. The third plenum runner 40 is operable to communicate intake air 24 to a third plenum 44 for subsequent introduction to at least one of the second cylinder 2, fourth cylinder 4, sixth cylinder 6, and eighth cylinder 8. The fourth plenum runner 42 is operable to communicate intake air 24 to a fourth plenum 46 for subsequent introduction to the at least one of the second cylinder 2, fourth cylinder 4, sixth cylinder 6, and eighth cylinder 8 that is not in fluid communication with the third intake plenum 44.

As illustrated in FIG. 1, the first and second intake plenum 36, and 38 are mounted in an outboard position with respect to the internal combustion engine 10. That is, the first and second intake plenum 36 and 38 are disposed substantially adjacent to the first bank of cylinders 14 opposite the valley 18. Similarly, the third and fourth intake plenum 44 and 46 are mounted in an outboard position with respect to the internal combustion engine 10. That is, the third and fourth intake plenum 44 and 46 are disposed substantially adjacent to the second bank of cylinders 16 opposite the valley 18. A compressor 48, such as a turbocharger or a supercharger, may be provided in fluid communication with the intake manifold assembly 22, and operate to selectively pressurize the intake air 24 within the intake manifold assembly 22.

The intake manifold assembly 22 as shown in FIG. 1 is configured for a sequential cylinder firing sequence of the first cylinder 1, second cylinder 2, seventh cylinder 7, eighth cylinder 8, fourth cylinder 4, fifth cylinder 5, sixth cylinder 6, and third cylinder 3, or what is commonly referred to as a 1-2-7-8-4-5-6-3 firing order. With this configuration, the close firing pair of cylinders 20 on the first bank of cylinders 14 are the third cylinder 3 and the first cylinder 1. The first intake plenum 36 is configured to communicate intake air 24 to the first cylinder 1, and the second intake plenum 38 is configured to communicate intake air to the third cylinder 3, fifth cylinder 5, and seventh cylinder 7. The close firing pair of cylinders 20 on the second bank of cylinders 16 are the eighth cylinder 8 and the fourth cylinder 4. The third intake plenum 44 is configured to communicate intake air 24 to the second cylinder 2 and fourth cylinder 4, and the fourth intake plenum 46 is configured to communicate intake air to the sixth cylinder 6 and eighth cylinder 8. By configuring the intake manifold assembly 22 in this way, the tuning effects of the close firing pair of cylinders 20 on each of the first and second bank of cylinders 14 and 16 may be substantially attenuated.

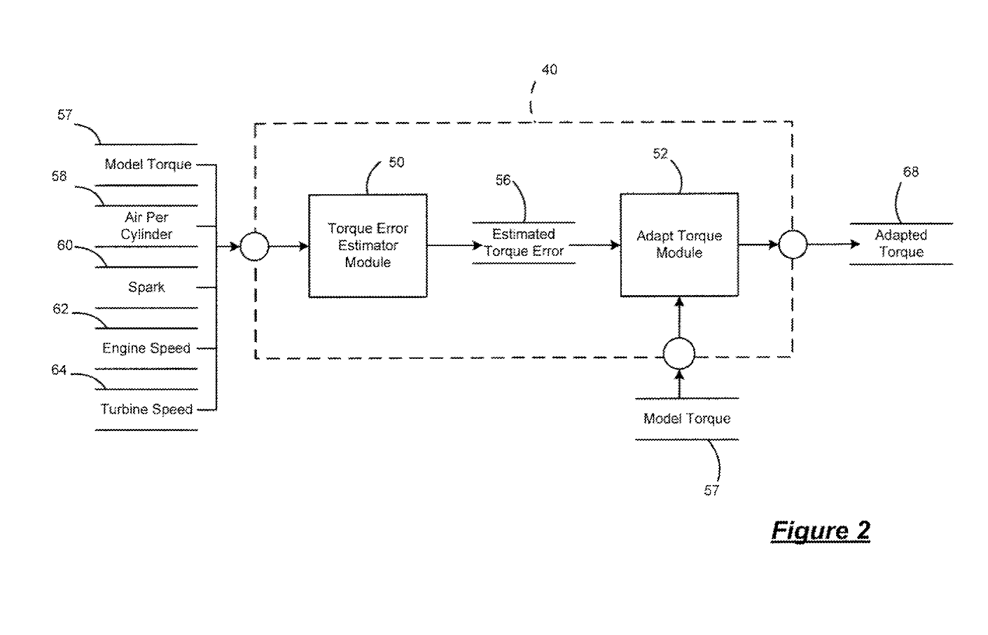

Referring now to FIG. 2 there is shown the internal combustion engine 10 having an alternate embodiment of the intake manifold assembly 22, shown in FIG. 1, and generally indicated as 22A. The intake manifold assembly 22A is configured for a sequential cylinder firing sequence of the first cylinder 1, fifth cylinder 5, sixth cylinder 6, third cylinder 3, fourth cylinder 4, second cylinder 2, seventh cylinder 7, eighth cylinder 8, or what is commonly referred to as a 1-5-6-3-4-2-7-8 firing order. With this configuration, the close firing pair of cylinders 20 on the first bank of cylinders 14 are the first cylinder 1 and the fifth cylinder 5. The first intake plenum 36 is configured to communicate intake air 24 to the first cylinder 1, and the third cylinder 3, and the second intake plenum 38 is configured to communicate intake air 24 to the fifth cylinder 5 and seventh cylinder 7. The close firing pair of cylinders 20 on the second bank of cylinders 16 are the fourth cylinder 4 and the second cylinder 2. The third intake plenum 44 is configured to communicate intake air 24 to the second cylinder 2, and the fourth intake plenum 46 is configured to communicate intake air 24 to the fourth cylinder 4, sixth cylinder 6, and eighth cylinder 8. By configuring the intake manifold assembly 22A in this way, the tuning effects of the close firing pair of cylinders 20 on each of the first and second bank of cylinders 14 and 16 may be substantially attenuated.

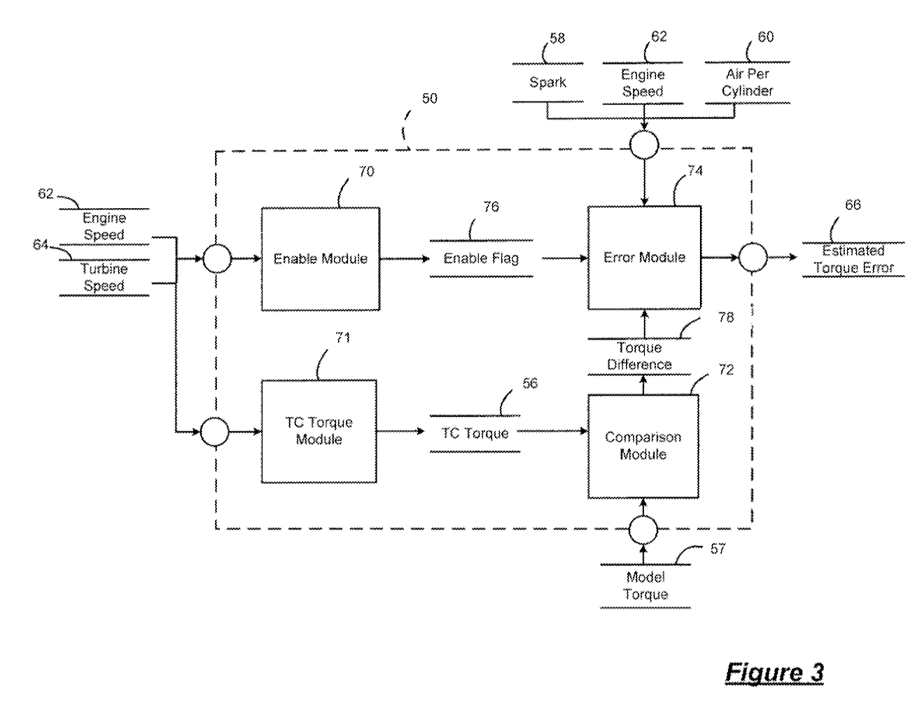

Referring now to FIG. 3 there is shown the internal combustion engine 10 having an alternate embodiment of the intake manifold assembly 22, shown in FIG. 1, and generally indicated as 22B. The intake manifold assembly 22B is configured for a sequential cylinder firing sequence of the first cylinder 1, second cylinder 2, seventh cylinder 7, third cylinder 3, fourth cylinder 4, fifth cylinder 5, sixth cylinder 6, and eighth cylinder 8, or what is commonly referred to as a 1-2-7-3-4-5-6-8 firing order. With this configuration, the close firing pair of cylinders 20 on the first bank of cylinders 14 are the seventh cylinder 7 and the third cylinder 3. The first intake plenum 36 is configured to communicate intake air 24 to the first cylinder 1, and the third cylinder 3, and the second intake plenum 38 is configured to communicate intake air 24 to the fifth cylinder 5 and seventh cylinder 7. The close firing pair of cylinders 20 on the second bank of cylinders 16 are the sixth cylinder 6 and the eight cylinder 8. The third intake plenum 44 is configured to communicate intake air 24 to the fourth cylinder 4, sixth cylinder 6, and eighth cylinder 8, and the fourth intake plenum 46 is configured to communicate intake air 24 to the second cylinder 2. By configuring the intake manifold assembly 22B in this way, the tuning effects of the close firing pair of cylinders 20 on each of the first and second bank of cylinders 14 and 16 may be substantially attenuated.

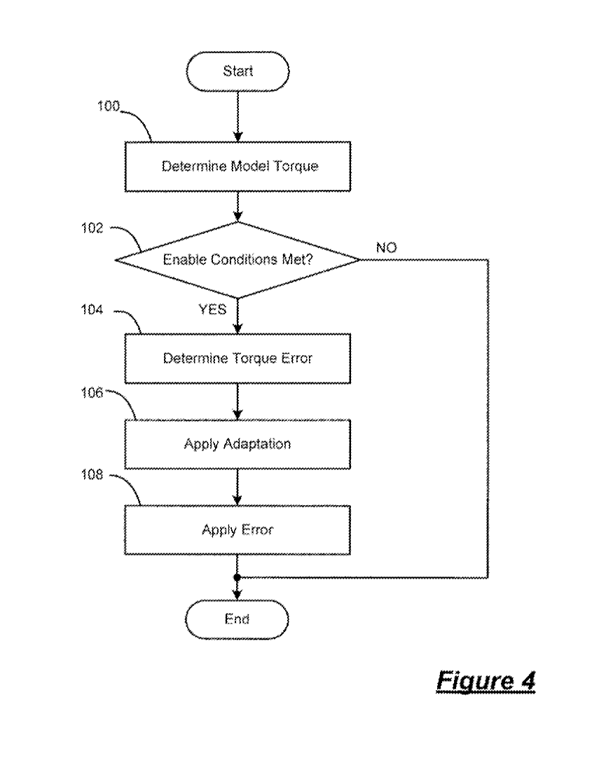

Referring now to FIG. 4 there is shown the internal combustion engine 10 having an alternate embodiment of the intake manifold assembly 22, shown in FIG. 1, and generally indicated as 22C. The intake manifold assembly 22C is configured for a sequential cylinder firing sequence of the first cylinder 1, second cylinder 2, sixth cylinder 6, third cylinder 3, fourth cylinder 4, fifth cylinder 5, seventh cylinder 7, and eight cylinder 8, or what is commonly referred to as a 1-2-3-4-5-7-8 firing order. With this configuration, the close firing pair of cylinders 20 on the first bank of cylinders 14 are the fifth cylinder 5 and the seventh cylinder 7. The first intake plenum 36 is configured to communicate intake air 24 to the first cylinder 1, third cylinder 3, and fifth cylinder 5, and the second intake plenum 38 is configured to communicate intake air 24 to the seventh cylinder 7. The close firing pair of cylinders 20 on the second bank of cylinders 16 are the second cylinder 2 and the sixth cylinder 6. The third intake plenum 44 if configured to communicate intake air 24 to the second cylinder 2 and fourth cylinder 4, and the fourth intake plenum 46 is configured to communicate intake air 24 to the sixth cylinder 6 and eighth cylinder 8. By configuring the intake manifold assembly 22C in this way, the tuning effects of the close firing pair of cylinders 20 on each of the first and second bank of cylinder 14 and 16 may be substantially attenuated.

By effectively separating the flow path of intake air 24 to the close firing pair of cylinders 20 on each of the first and second banks of cylinders 14 and 16, the cylinder-to-cylinder combustion variation of the internal combustion engine 10 may be substantially reduced. This reduction in variation may improve power density and exhaust emissions of the internal combustion engine 10.

While the best modes for carrying out the invention have been described in detail, those familiar with the art to which this invention relates will recognize various alternative designs and embodiments for practicing the invention within the scope of the appended claims.

What is claimed is:

1. A torque estimation system for controlling an internal combustion engine, comprising:
a torque error estimator module that estimates a torque error based on an error propagation model and a plurality of torque model parameters; and
an adapt torque module that adapts a model torque based on the torque error.

2. The system of claim 1 further comprising a torque model module that computes a model torque based on a mathematical torque model.

3. The system of claim 2 wherein the torque model is at least one of a regression torque model and a physical model.

4. The system of claim 1 wherein the torque error estimator module comprises:
a torque converter torque module that computes a torque converter (TC) torque based on a torque converter model;
a comparison module that computes a difference between the TC torque and the model torque; and
an error module that generates the torque error based on the difference, the error propagation model, and the plurality of torque model parameters.

5. The system of claim 4 wherein the torque converter model is a multi-region Kotwicki model.

6. The system of claim 5 wherein regions of the multi-region Kotwicki model are based on slip.

7. The system of claim 1 wherein the plurality of torque model parameters are at least one of spark, engine speed, and air per cylinder.

8. The system of claim 1 wherein the plurality of torque model parameters are based on at least one of friction, engine load, and accessory load.

9. The system of claim 1 further comprising an enable module that selectively enables the torque error estimator to estimate the torque error wherein the enable module selectively enables the torque error estimation based on slip ratio and steady state conditions.

10. The system of claim 9 wherein the enable module determines slip ratio based on engine speed and turbine speed.

11. The system of claim 9 where the steady state conditions are determined from a derivative of a delta slip.

12. A method for estimating engine torque for use in controlling internal combustion engines, comprising:
computing a model torque based on a torque model;
determining a torque error model based on an error propagation analysis of torque model parameters of the torque model;
applying an adaptation method to the torque error model to determine a torque error; and
computing an estimated torque based on the torque error and the model torque.

13. The method of claim 12 wherein the determining comprises determining the torque error model when enable conditions are met and wherein the enable conditions are based on slip and steady state conditions.

14. The method of claim 13 further comprising computing slip based on engine speed and turbine speed.

15. The method of claim 13 further comprising determining steady state conditions based on a derivative of a delta slip.

16. The method of claim 12 wherein the adaptation method is a weighted recursive least squares method.

17. The method of claim 12 wherein the computing an estimated torque comprises adding the torque error to the model torque.

18. The method of claim 12 wherein the computing a model torque comprises computing a model torque based on a mathematical model of torque.

19. The method of claim 18 wherein the mathematical model is at least one of a regression torque model and a physical model.
